(19) United States
(12) Patent Application Publication
(10) Pub. No.: US 2018/0121493 A1
(43) Pub. Date: May 3, 2018

(54) DETECTING EMERGENCY RESPONSE ADDRESS ERRORS

(71) Applicant: Cisco Technology, Inc., San Diego, CA (US)

(72) Inventor: Derrick Pallas, San Jose, CA (US)

(21) Appl. No.: 15/343,006

(22) Filed: Nov. 3, 2016

(51) Int. Cl. G06F 17/30; H04L 29/12; G01S 19/17

(52) U.S. Cl. CPC G06F 17/30377; H04L 61/609; H04M 2242/04; G01S 19/17; G06F 17/30241

(57) ABSTRACT

Aspects of the subject technology relate to an internet-protocol (IP) telephone system that is configured to perform operations including, estimating a location of the IP telephone system, determining if the estimated location of the IP telephone system is represented in an emergency response (ER) address database, and in response to determining that the estimated location of the IP telephone system is not represented in an ER address database, generating a user prompt for the IP telephone system. In some aspects, computer-implemented methods and machine-readable media are also provided.

### BACKGROUND

### 1. Technical Field

The disclosed technology relates to methods and systems for detecting potentially erroneous emergency response (ER) address information and for prompting user updates to outdated ER information.

### 2. Introduction

Increasing network connection speeds have encouraged the proliferation of portable IP-based telephone devices. However, one downside of device portability is an increased likelihood that address information associated with the device telephone number is outdated or inaccurate. For example, emergency response (ER) databases that typically maintain address/telephone information may fall out-of-date as users transport their IP-telephony devices between locations. Additionally, conventional ER address databases are often maintained by a network administrator or another third-party, making it difficult for end users to unilaterally update or maintain their ER address information.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates steps of an example process for identifying outdated Emergency Response (ER) address information, according to some aspects of the technology.

FIG. 2 illustrates an example environment in which aspects of an ER address information update process can be performed.

FIG. 3 conceptually illustrates an example of hardware modules that can be used to implement an IP telephone device, according to some aspects of the technology.

FIGS. 4A and 4B illustrate example system embodiments.

### DESCRIPTION OF EXAMPLE EMBODIMENTS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview

Aspects of the subject disclosure relate to an internet-protocol (IP) telephone device configured to perform operations for maintaining accurate/updated ER address information. As discussed in further detail below, an IP telephone device can be configured to perform operations, using one or more processors, including: estimating a location of the IP telephone device, determining if the estimated location is represented in an emergency response (ER) address database, and in response to determining that the estimated location of the IP telephone system is not represented in an ER address database, generating a user prompt for the IP telephone system, wherein the user prompt provides a query for the verification of current ER address information and/or for updated ER address information.

### Example Embodiments

Aspects of the subject technology address some of the limitations of conventional ER database systems by providing systems/methods for identifying incorrect address information and prompting user updates to maintain ER address accuracy.

In some aspects, the technology includes an IP-based telephone device having a unique a telephone number that is also paired with a corresponding physical address for use by emergency responders, e.g., an emergency responder address or ER address. Associations between telephone numbers and physical addresses information can be maintained in an ER database, for example, that resides locally, for example, on the IP telephone device, and/or that is stored remotely, such as in a cloud based storage system. Depending on implementation, initial ER address information can be pre-programmed (e.g., initialized to a mailing address of the receiving customer), or requested upon device setup. Subsequently, virtual/physical address associations can be monitored to determine if physical address information should be updated.

In some aspects, the IP telephone device can be configured to automatically associate public IP address information with a physical address for the device. Detected changes in public IP address can be used to trigger user prompts to request address confirmation and/or the input of new/updated address information. For example, an IP telephone associated with a first network (IP) address at a user's home may detect a change in an assigned public IP address. In response, the device can prompt the user to verify the home location information. In instances where address accuracy is verified, a new (or additional) public IP address can be associated with physical address, for example, so that repeated changes between known IP assignments are prevented from trigging future queries.

In another aspect, geo-location information of the device can be used to determine if address updates are needed. For example, some IP telephone devices include global positioning system (GPS) hardware that can identify an approximate geo-location of the device. In such instances, geolocation coordinates can be associated with ER address information and used to determine when address updates might be needed. Prompts for updated address information can be provided to the user in response to a determination that the device has moved beyond a predetermined threshold distance from a prior location, e.g., a location that was associated valid ER address information.

Depending on implementation, geo-location can be determined using GPS hardware, as discussed above, and/or using location estimates based on signaling received from one or more radio networks. For example, location estimates can be based on pre-determined location information for one or more WiFi network “hotspots.” Such approaches can make use of a geo-IP database that contains address and/or location information for known wireless networks, for example, that correlates location information with one or more WiFi network Service Set Identifiers (SSIDs). It is understood that other heuristics can be used to determine location changes of the IP telephone device, without departing from the scope of the technology.

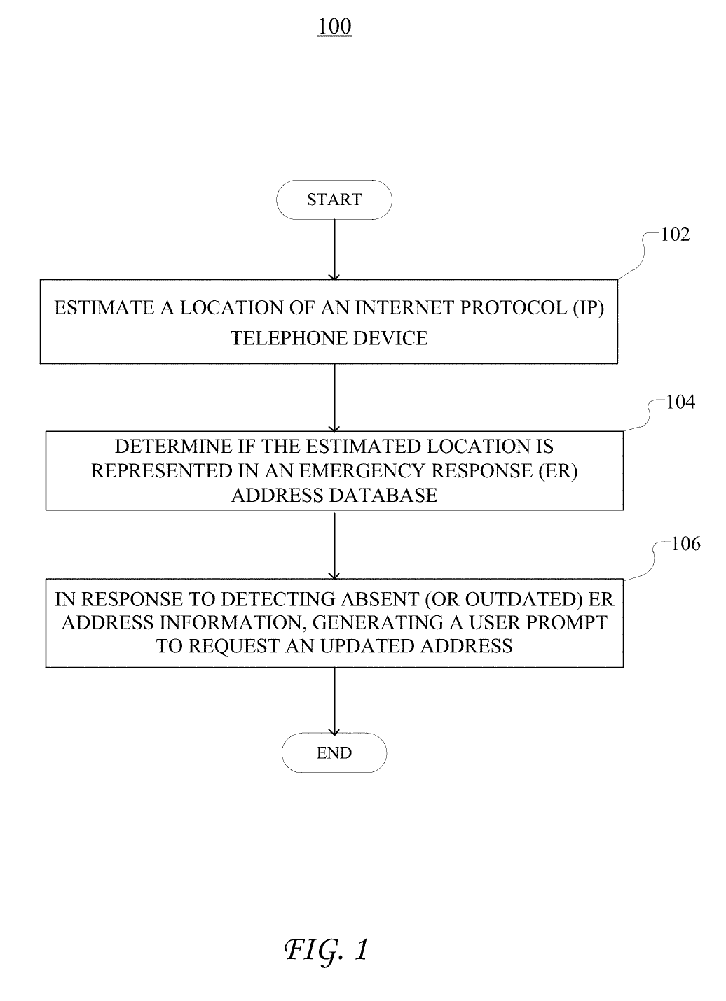

FIG. 1 illustrates steps of an example process 100 for identifying outdated Emergency Response (ER) address information. Process 100 begins with step 102 in which a location estimate of the IP telephone device is performed. As discussed above, location estimates can be performed using a variety of techniques and/or signals obtainable by the IP device. For example, the determination of a location estimate may involve determinations as to whether or not the IP telephone device appears to have been relocated for a previously known position.

In some aspects, the IP telephone device can be configured to periodically determine an associated IP address, e.g., a “public” IP address assignment corresponding with device's Internet connection. Depending on implementation, changes in public IP address assignment can indicate a change of geographical location (and hence a need to change/update ER address assignment). As discussed in further detail below, public IP address assignments may not always indicate a change in device location, and in some instances it may be useful keep a record of public IP address and ER address assignment pairs for the purpose of identifying conditions where dynamic IP address updates may not correspond with location changes.

In some aspects, location information of the IP telephone device is estimated based on location information provided by a geolocation positioning system (GPS). That is, one or more GPS chips of the IP telephone device can be used to estimate the device's geo-location, and thereby infer when updates/changes to ER address information may be required. Because GPS geolocation information can change between readings and offers only limited accuracy, in some aspects, identified changes in GPS location information that fall below a predetermined distance threshold may be ignored. By way of example, a user moving her IP telephone device from one room to another in her home may register a relatively small change in geo-location, however, such changes may be below a predetermined distance threshold, and therefore ignored and without causing further steps to be performed that require user-location confirmation.

In yet another aspect, location information of the IP telephone device can be estimated using a geo-IP database, for example, that maintains a record of known WiFi networks and address information. As discussed above, geo-IP databases can be used to store network SSIDs and associated address information for a variety of detectable WiFi networks. As such, identification of one or more proximately located WiFi networks by the IP telephone device can be used to query the geo-IP database to determine the availability of address information.

Additionally, it is understood that other location approximation (or address approximation) techniques can be implemented, without departing from the scope of the technology. For example, address approximations may be determined using information provided by a wireless network protocol, for example, such as that provided by amendment to the WiFi standard in the 802.11k revision, and/or subsequent standard revisions, etc.

In step 104, the IP telephone device can determine if the estimated location is already represented in an ER address database. That is, the IP telephone device can determine if indications of a potentially new location (acquired in step 102), are in fact new and therefore require updates to the ER address associated with the IP telephone device. As discussed above, the ER address database may be maintained locally (e.g., on the IP telephone device), or may be stored remotely across one or more devices, such as on a cloud controller, or in a cloud data center. As such, verifications of existing ER address information can include the transmission of one or more queries, and receipt of one or more replies, with a variety of remote network elements.

In instances where changes in public IP address information are detected, the ER address database may be referenced to determine if the newly assigned IP address is already associated with an ER address assignment. For example, some Internet service providers (ISPs) make dynamic IP address assignments to customers, and thus, public IP addresses can change without corresponding changes in physical/ER address information. Therefore, in instances where a new public IP address assignment is already associated with ER address information in the ER address database, it may be determined that no updates are needed. Alternatively, if a new public IP address assignment is not associated with ER address information then updates/changes can be requested from the user, as discussed in further detail with respect to step 106, below.

In approaches where changes in geolocation information are detected, e.g., using a GPS chip, location changes above a predetermined threshold distance may be required before it is determined that updated ER address information should be required. As mentioned above, the user of an IP telephone device may decide to move the device between one or more rooms of her house, which would not typically necessitate the update of the corresponding ER address. However, for geolocation changes of a greater magnitude (e.g. moving across the street or to another area of town), ER address updates may be desired. Therefore in some aspects, geolocation changes below a predetermined threshold distance may not result in a determination that ER address updates are desired.

By way of example, geolocation changes below 100 meters may be ignored, whereas geolocation changes above 200 meters can trigger a request for user updates, as discussed in step 106, below. It is understood that other distance thresholds may be implemented without departing from the scope of the subject technology.

In instances wherein ER address information is estimated using a geo-IP database, location changes may be indicated by the presence of WiFi SSIDs that are either unknown, or known to be associated with different geolocations than that associated with the IP telephone device. Additionally, in some aspects, location changes may be identified from the absence of known SSIDs in the geo-location database e.g., pertaining to one or more networks corresponding with a previous location of the IP telephone device. Both types of changes in geo-IP database information can result in a determination that ER address confirmations or updates are needed.

Regardless of the type of location estimation used, in some aspects, an average centroid distance can be calculated and used as a heuristic for the default or “average” location approximation of the IP telephone device. For example, GPS location estimates can vary slightly from reading to reading. Similarly, geo-IP database location estimates can vary. As such, average centroid distances can be used to approximate GPS estimates and/or geo-IP location estimates. In some embodiments, centroid-based approximations can be calculated based on weighted averages of different location estimation techniques, for example, where more accurate estimation techniques (e.g., GPS location estimations) are more highly weighted.

In step 106, a user prompt is generated in response to the detection of outdated ER address information (e.g., from step 104). In some aspects, the generated user prompt can be provided by the IP telephone device to the user. Generated user prompts can contain various types of information and/or user queries, depending on implementation. For example, the user prompt can provide an indication of a current ER address assignment and simply request that the user verify the ER address information. Alternatively, the user prompt may require the user to enter new or current address information before device operation can proceed.

In some aspects, default ER address information can be initialized for a telephone number of the IP device. For example, customer shipping address information may be used as a default. Additionally, initial address information can be acquired in when the device is setup, e.g., by requiring customer/user input of ER address information before setup can be completed.

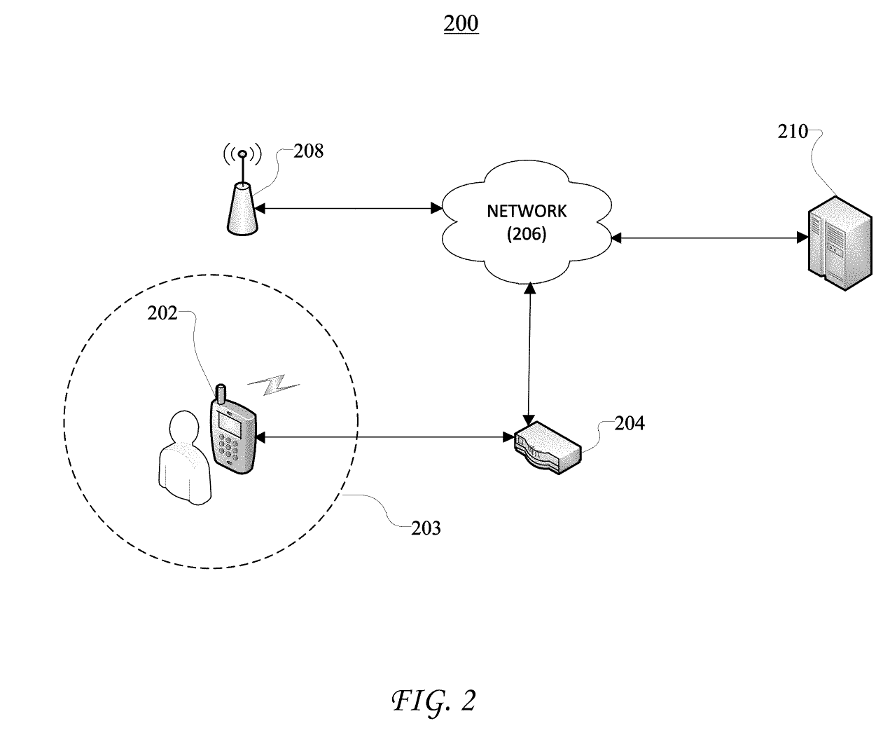

FIG. 2 illustrates an example environment 200 in which aspects of an ER address update process can be performed. Environment 200 includes IP telephone device 202, router 204, network 206, a wireless access point 208, and a geo-IP database 210. As illustrated, IP telephone device 202 is associated with a user, and is configured to be communicatively coupled with geo-IP database 210, e.g., via router 204 and/or wireless access point 208.

Also illustrated in environment 200 is distance threshold 203 which specifies a predetermined distance beyond which geolocation information of IP telephone device 202 would be determined to require additional update and/or verification.

It is understood that environment 200 is provided to conceptually illustrate an example environment in which some aspects of the technology can be implemented; however, other network environments and/or configurations, including a greater or fewer number of network elements, may be used without departing from the scope of the subject technology. Additionally, it is understood that wireless access point 208 can represent one or more of a variety of radio networks, including but not limited to: a WiFi network, a Bluetooth network, or a Long-Term Evolution (LTE) carrier, etc. Similarly, network 206 can represent one or more private and/or public network such as one or more local area networks (LANs), wide area networks (WANs), or a network of networks, such as the Internet.

As illustrated in FIG. 2, IP telephone device 202 is communicatively coupled geo-IP database 210 via network 206, and router 204. In some implementations, IP telephone device 202 may additionally (or alternatively) be coupled to geo-IP database 210 via a wireless access point, such as wireless access point 208.

In operation, IP telephone device 202 can be configured to carry out operations (e.g., as discussed with respect to FIG. 1) to determine if updated ER address information should be solicited from the user. Further to the foregoing examples, detected changes in location cause IP telephone device 202 to generate and provide prompts to the user, for example, to verify previous (or request new) ER address information.

By way of example, router 204 may be a switch/router device operated by a public utility or Internet provider, e.g., an ISP. Changes to a public IP address that are assigned to IP telephone device 202, by router 204, can indicate either a change in location of IP telephone device 202, or simply an update to the dynamic IP address assignment made by router 204. As discussed above, such changes in public IP address assignment can cause IP telephone device 202 to generate user prompt ensure the accuracy of any pre-existing ER address information.

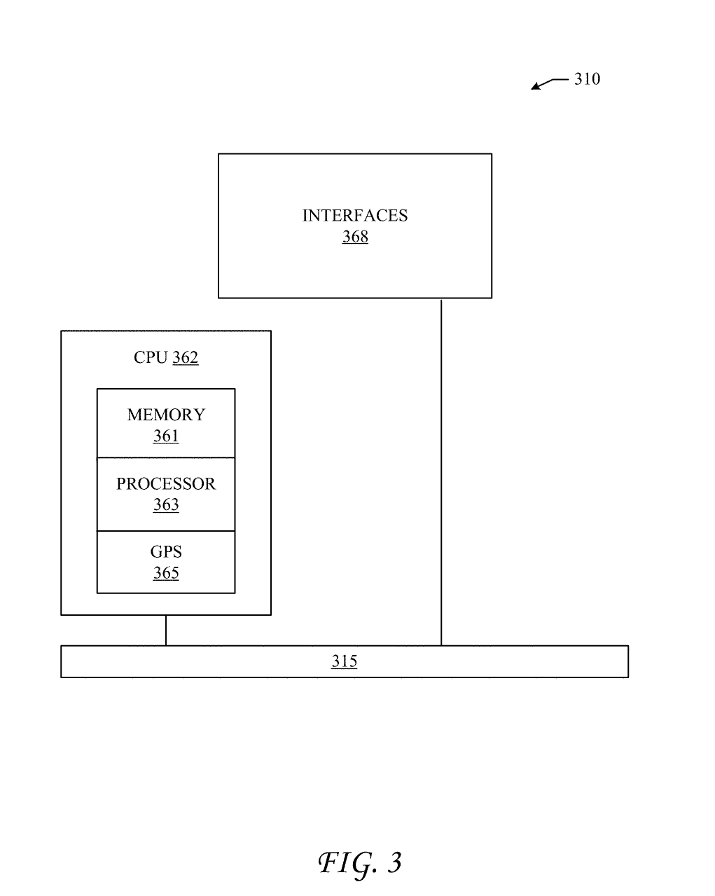

In another example, IP telephone device 202 can include one or more sensors to facilitate determinations of a location of the device. As discussed in further detail below with respect to FIG. 3, IP telephone device 202 can include one or more GPS chips/devices that provide estimated geolocation coordinates of the IP telephone device. In such approaches, determinations of a location change by IP telephone device 202 can also be used to cause the generation of user prompts to request updated ER address information.

As indicated in the example of environment 200, IP telephone device 202 is associated with distance threshold 203 that defines a distance boundary condition for a geo-location of the device, outside which, the device is considered to be in a new location, requiring updated ER address information.

Further to the above examples, geo-IP database 210 can also be used by IP telephone device 202 to approximate an address location. By way of example, IP telephone device 202 may detect one or more wireless access points in the surrounding area and provide information pertaining to the one or more access points to geo-IP database 210 in order to perform a “lookup” of the present address location. That is, IP telephone device 202 can detect one or more SSIDs associated with one or more respective WiFi networks and provide at least one of the SSIDs to geo-IP database 210. In response, geo-IP database 210 can provide known address information (if any) pertaining to the SSID provided by IP telephone device 202. As discussed above, in instances where the surrounding WiFi access points appear to be different from those of a known location associated with IP telephone device 202, ER address verification (or an address request) can be provided to the associated user.

FIG. 3 conceptually illustrates an example of a network device (e.g., an IP telephone device) 310 that can be used to perform an ER address verification method, according to some aspects of the technology.

Specifically, FIG. 3 network device 310 includes a master central processing unit (CPU) 362, interfaces 368, and a bus 315 (e.g., a PCI bus). When acting under the control of appropriate software or firmware, CPU 362 is responsible for performing ER address look up and verification operations, as discussed above. CPU 362 preferably accomplishes all these functions under the control of software including an operating system and any appropriate applications software. CPU 362 can include one or more processors 363 such as a processor from the Motorola family of microprocessors or the MIPS family of microprocessors. In an alternative embodiment, processor 363 is specially designed hardware for controlling the operations of router 310. In a specific embodiment, a memory 361 (such as non-volatile RAM and/or ROM) also forms part of CPU 362. However, there are many different ways in which memory could be coupled to the system. In some implementations, CPU 362 can also include one or more circuits or chipsets that are configured to detect a location (e.g. a geolocation) of the associated IP telephone device.

Interfaces 368 are typically provided as wireless network cards. Generally, they control the sending and receiving of data packets over a wireless network (such as network 206 discussed above with respect to FIG. 2) and sometimes support other peripherals used with the router 204. The interfaces that can be provided by network interfaces 368 can include: wireless network interfaces, Ethernet interfaces, frame relay interfaces, cable interfaces, DSL interfaces, token ring interfaces, and the like.

In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 362 to efficiently perform routing computations, network diagnostics, security functions, etc.

Although the system shown in FIG. 3 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 361) configured to store program instructions for the general-purpose network operations and mechanisms for roaming, route optimization and routing functions described herein. The program instructions may control the operation of an operating system and/or one or more applications.

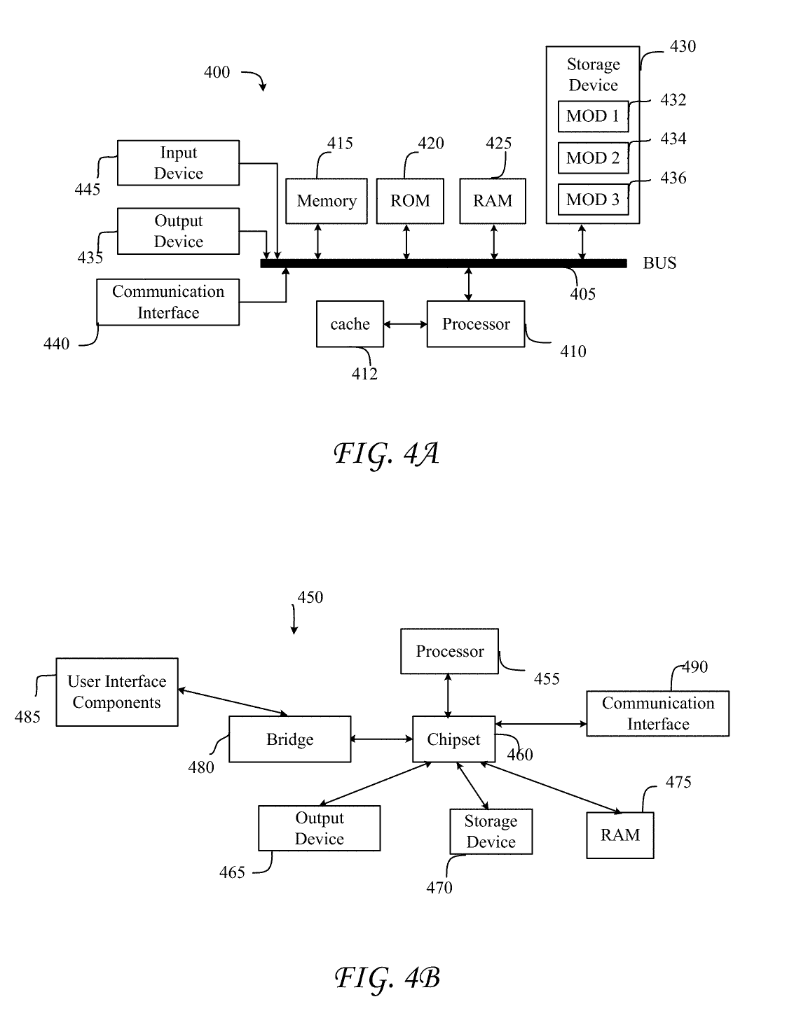

FIG. 4A and FIG. 4B illustrate example system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates an example computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output device 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that example systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

What is claimed is:

1. An internet-protocol (IP) telephone system, comprising:
one or more processors; and
a non-transitory memory coupled to the one or more processors, wherein the processors are configured to perform operations comprising:
estimating a location of the IP telephone system;
determining if the estimated location of the IP telephone system is represented in an emergency response (ER) address database; and
in response to determining that the estimated location of the IP telephone system is not represented in an ER address database, generating a user prompt for the IP telephone system.

2. The IP telephone system of claim 1, wherein estimating the location of the telephone system further comprises:
determining a public IP address associated with the IP telephone system.

3. The IP telephone system of claim 1, further comprising:
a global-positioning system (GPS) module coupled to the one or more processors, and
wherein estimating the location of the IP telephone system further comprises determining a geo-location of the IP telephone system using the GPS module.

4. The IP telephone system of claim 1, wherein estimating the location of the IP telephone system further comprises:
identifying one or more radio networks proximately located to the IP telephone system; and
querying a geo-IP database to determine a location estimate based at least in part on a Service Set Identifier (SSID) associated with at least one of the one or more radio networks.

5. The IP telephone system of claim 4, wherein the one or more radio networks comprises one or more of: a WiFi network, a Bluetooth network, or a Long-Term Evolution (LTE) network.

6. The IP telephone system of claim 1, wherein the user prompt comprises a request to update ER address information associated with the IP telephone system.

7. The IP telephone system of claim 1, wherein the user prompt comprises a current ER address association for the IP telephone system and a user query to verify the current ER address association.

8. A method for updating emergency responder (ER) address information, the method comprising:
estimating a location of an internet protocol (IP) telephone device;
determining if the estimated location of the IP telephone device is represented in an emergency response (ER) address database; and
in response to determining that the estimated location of the IP telephone device is not represented in an ER address database, generating a user prompt for the IP telephone device.

9. The method of claim 8, wherein estimating the location of the telephone device further comprises:
determining a public IP address associated with the IP telephone device.

10. The method of claim 8, wherein estimating the location of the IP telephone device further comprises determining a geo-location of the IP telephone device using a GPS module.

11. The method of claim 8, wherein estimating the location of the IP telephone device further comprises:
identifying one or more radio networks proximately located to the IP telephone device; and
querying a geo-IP database to determine a location estimate based at least in part on a Service Set Identifier (SSID) associated with at least one of the one or more radio networks.

12. The method of claim 11, wherein the one or more radio networks comprises one or more of: a WiFi network, a Bluetooth network, or a Long-Term Evolution (LTE) network.

13. The method of claim 8, wherein the user prompt comprises a request to update ER address information associated with the IP telephone device.

14. The method of claim 8, wherein the user prompt comprises a current ER address association for the IP telephone device and a user query to verify the current ER address association.

15. A non-transitory computer-readable storage medium comprising instructions stored therein, which when executed by one or more processors, cause the processors to perform operations comprising:
estimating a location of an IP telephone system;
determining if the estimated location of the IP telephone system is represented in an emergency response (ER) address database; and
in response to determining that the estimated location of the IP telephone system is not represented in an ER address database, generating a user prompt for the IP telephone system.

16. The non-transitory computer-readable storage medium of claim 15, wherein estimating the location of the telephone system further comprises:
determining a public IP address associated with the IP telephone system.

17. The non-transitory computer-readable storage medium of claim 15, wherein estimating the location of the IP telephone system further comprises determining a geo-location of the IP telephone system using a GPS module.

18. The non-transitory computer-readable storage medium of claim 15, wherein estimating the location of the IP telephone system further comprises:
identifying one or more radio networks proximately located to the IP telephone system; and
querying a geo-IP database to determine a location estimate based at least in part on a Service Set Identifier (SSID) associated with at least one of the one or more radio networks.

19. The non-transitory computer-readable storage medium of claim 18, wherein the one or more radio networks comprises one or more of: a WiFi network, a Bluetooth network, or a Long-Term Evolution (LTE) network.

20. The non-transitory computer-readable storage medium of claim 15, wherein the user prompt comprises a request to update ER address information associated with the IP telephone system.
